(19) United States
(12) Patent Application Publication
(10) Pub. No.: US 2026/0342163 A1
(43) Pub. Date: Oct. 29, 2026

(54) DEVICE FOR ELECTRICAL CONNECTION BETWEEN AN ELECTRIC MACHINE AND A POWER ELECTRONICS MODULE

(71) Applicant: AMPERE S.A.S., Boulogne Billancourt (FR)

(72) Inventors: Fabrice BOISADAN, Guyancourt (FR); Nicolas MARCHAL, Guyancourt (FR); Frederic MAUDET, Guyancourt (FR)

(73) Assignee: AMPERE S.A.S., Boulogne Billancourt (FR)

(21) Appl. No.: 19/118,937

(22) PCT Filed: Sep. 14, 2023
(86) PCT No.: PCT/EP2023/075323

§ 371 Date: Jun. 26, 2026

(30) Foreign Application Priority Data
Oct. 7, 2022 (FR) FR2210311

(51) Int. Cl. H02K 3/50; H01R 4/34; H02K 5/22; H02K 11/33; H02K 15/32

(52) U.S. Cl. CPC H02K 3/50; H01R 4/34; H02K 5/225; H02K 11/33; H02K 15/32; H01R 2201/10; H02K 2203/09

(57) ABSTRACT

An electrical connection device electrically connecting an electric machine and a power electronics module. The device includes phase bars which are connected to the electric machine, feed bars which are connected to the power electronics module, a portion of a phase bar and a portion of a feed bar being spaced apart from and parallel to one another, the portions including connection terminals, and a conductive pad electrically connecting the connection terminals of the portions, which are held together by a retaining element that passes through the conductive pad.

The present invention relates to the field of electrical engineering, and relates more specifically to an electrical connection device for electrical connection between an electrical machine and a power electronics module.

In an electric or hybrid-electric vehicle, the electric traction/propulsion motor is supplied with an AC current formed by a power electronics module, which is itself supplied with DC current by what is known as a high-voltage electric battery, that is to say with a voltage of the order of several hundred volts. The electric traction/propulsion motor is generally a polyphase electrical machine that is used in motor or generator mode depending on the use of the vehicle. The power electronics module houses an inverter, and possibly an electrical charger that is used when charging the high-voltage electric battery.

Now, the engine compartment of a hybrid-electric vehicle has to house, in addition to an electrical machine, power electronics module and high-voltage electric battery, the components of another powertrain, for example a thermal combustion engine and a gear reducer. The engine compartment is therefore highly crowded and its various elements have to be arranged tightly against one another. This means having to design electrical connections between these elements that take up as little space as possible. Now, to put the outputs of the electrical machine and of the power electronics module into contact, it is common practice to extend for example the outputs of the power electronics module in order to bend them and bring them into contact with the outputs of the electrical machine, thereby consuming space in the engine compartment.

In addition, in the case where the electrical machine comprises two stators, the number of electrical connections of the electrical machine to the power electronics module is doubled, thereby complicating the task of providing access to each of these connections in order to mount/dismount them, without increasing the volume to be left free in the engine compartment to allow this access.

The present invention at least partially overcomes the drawbacks of the prior art by providing an electrical connection device for electrical connection between an electrical machine and a power electronics module, an assembly of an electrical machine and power electronics module, and a method for assembling the electrical connection device, which allow for simplified assembly of the connections between the electrical machine and the power electronics module, while at the same time requiring very little space for mounting or dismounting them.

To this end, the invention proposes an electrical connection device intended to electrically connect an electrical machine and a power electronics module, the electrical connection device comprising:
a plurality of phase busbars, able to be connected to the electrical machine, and
a corresponding plurality of power supply busbars, able to be connected to the power electronics module,
said pluralities comprising pairs consisting of a phase busbar portion and a power supply busbar portion, the portions in each pair being spaced apart and parallel to one another,
the electrical connection device being characterized in that said portions comprise connection terminals and in that the electrical connection device comprises:
a plurality of conductive pads electrically connecting the connection terminals of the pairs, the conductive pads being intended to pass through at least one orifice in a wall of the electrical machine, and
a plurality of holding elements for holding the electrically connected connection terminals, at least one conductive pad being passed through by one of the holding elements.

By virtue of the invention, the electrical connections between the power electronics module and the electrical machine, in the form of power busbars, are very short and therefore do not take up much space, and allow an operator to easily mount or dismount them.

Indeed, this configuration of the power electronics device according to the invention makes it possible to electrically connect the power electronics module and the electrical machine without their respective outputs having to be superimposed in contact with one another, and therefore without the need to bend the power busbars to achieve this contact. The electrical machine comprises for example one or more stators whose connections to the power electronics module all benefit from these conductive pads for electrically connecting each stator connection to a power supply connection of the power electronics module. In this case, preferably, each conductive pad makes it possible to connect together a stator connection of each stator and a power supply connection. It should therefore be understood that the pairs of busbar portions may comprise one pair formed of a power supply busbar portion and a phase busbar portion of one stator, and another pair formed of the same power supply busbar portion and a phase busbar portion of another stator.

Moreover, the invention is applicable to a single-phase or polyphase electrical machine.

According to one advantageous feature of the electrical connection device according to the invention, it comprises an electrically insulating overmolding that holds at least two of the conductive pads together.

According to one embodiment, the electrically insulating overmolding comprises positioning means for positioning the plurality of phase busbars. This allows an operator to mount multiple conductive pads on the phase busbars simultaneously, without any offset between the conductive pads and the connection terminals of the phase busbars. Preferably, the electrically insulating overmolding holds all of the conductive pads in a single block of insulating material, inserted into an orifice in the wall of the electrical machine through an assembly movement in a single direction.

The positioning means are for example formed by a lug able to position the phase busbar portions in a primary direction of elongation of the phase busbar portions. As a variant, the positioning means are able, in addition or instead, to position the power supply busbar portions in the primary direction of elongation of the busbar portions.

According to one advantageous feature of the electrical connection device according to the invention, the electrically insulating overmolding comprises, in addition to or instead of the positioning means, centering means for centering at least one of the conductive pads on at least one of the connection terminals. These centering means assist with positioning the conductive pads on the connection terminals of the power supply or phase busbars, preferably in a direction different from the positioning assistance provided by the positioning means.

The centering means comprise for example at least one groove able to receive at least one corresponding rib of an insulating protection of at least one of the pluralities of busbars. As a variant, the centering means comprise at least one rib able to be inserted into a corresponding groove of an insulating protection of at least one of the pluralities of busbars.

In one embodiment, the connection device according to the invention furthermore comprises at least one nut mounted integrally with at least one of the connection terminals of the phase busbar portions, and the connection terminal is interposed between one of the conductive pads and the nut, the holding elements comprising at least one screw mounted in the conductive pad and screwed into the nut. Preferably, the conductive pads have a length greater than a dimension of the electrically insulating overmolding in a primary direction of elongation of the conductive pads. This facilitates electrical contact between the conductive pads and the connection terminals of the power supply or phase busbars.

In one embodiment of the invention, the electrical machine comprises two stators, the plurality of phase busbars comprising two busbars per phase, connected together at one end of one of the conductive pads, the other end of the conductive pad being connected to a corresponding portion of a power supply busbar. Said two busbars per phase are connected to said end of one of the conductive pads for example via a portion of one of the two phase busbars, this portion possibly comprising a nut for example.

The invention also relates to an assembly of an electrical machine and power electronics module, characterized in that it furthermore comprises an electrical connection device for electrically connecting the electrical machine to the power electronics module according to the invention.

Finally, the invention relates to a method for assembling an electrical connection device for electrically connecting an electrical machine to a power electronics module according to the invention, comprising the following steps:
electrically connecting the plurality of power supply busbars to the power electronics module,
electrically connecting the plurality of phase busbars to a stator of the electrical machine,
inserting the conductive pads into the at least one orifice in the wall of the electrical machine,
positioning the connection terminals of the power supply busbar portions so as to face the conductive pads, and
assembling the holding elements in the conductive pads.

In the embodiments of the invention in which the electrical machine comprises two stators and in which the holding elements each comprise a screw mounted in a conductive pad and screwed into a nut, a method for assembling an electrical connection device for electrically connecting an electrical machine to a power electronics module according to the invention comprises the following steps:
electrically connecting the plurality of power supply busbars to the power electronics module,
electrically connecting first phase busbars of the plurality of phase busbars to one of the stators of the electrical machine, the connection terminals of the first phase busbar portions each being joined integrally to a nut,
electrically connecting second phase busbars of the plurality of phase busbars to the other of the stators of the electrical machine and superimposing the connection terminals of second phase busbar portions on the connection terminals of the first phase busbar portions, on the side opposite the nuts,
inserting the conductive pads into the at least one orifice in the wall,
positioning the connection terminals of the power supply busbar portions so as to face the conductive pads, and
screwing screws into said nuts, the screws passing through the connection terminals of the power supply busbar portions, the conductive pads, the connection terminals of the first phase busbar portions and the connection terminals of the second phase busbar portions.

In these methods for assembling the connection device according to the invention, and in the assembly according to the invention:
the conductive pads are preferably inserted into the orifice in the wall of the machine through a single assembly movement of an electrically insulating overmolding that holds the conductive pads together in a first direction, and
the connection terminals of the power supply busbar portions are positioned so as to face the conductive pads through a single assembly movement in a second direction orthogonal to the first direction. In particular, this positioning step is carried out by inserting the plurality of power supply busbars into a hole in the wall of the electrical machine that is distinct from the orifice in the wall of the electrical machine. The assembling method therefore makes it possible to connect the electrical machine and the power electronics module in the engine compartment of a vehicle in just two assembly movements and one assembly or screwing step, thereby facilitating this connection in a very small space.

The assembly according to the invention and the assembling methods according to the invention have advantages analogous to those of the electrical connection device according to the invention, and vice versa.

Other features and advantages of the invention will become more apparent from the following description, on the one hand, and from a plurality of non-limiting exemplary embodiments that are given by way of indication with reference to the appended schematic drawings, on the other hand, in which drawings:

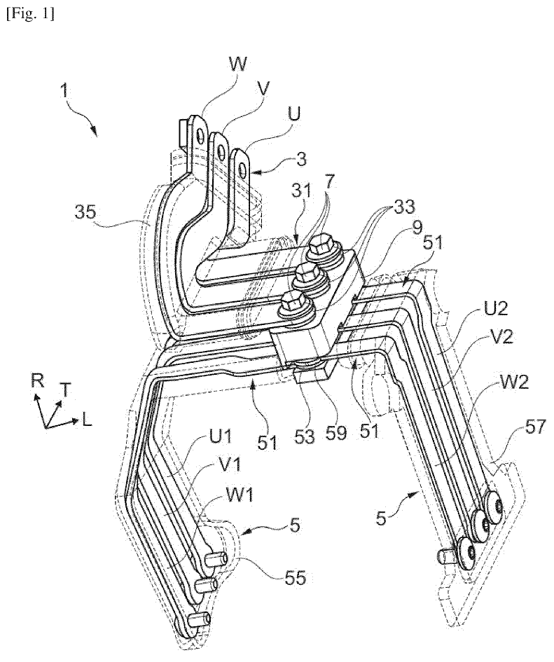

FIG. 1 is a perspective view of an electrical connection device according to the invention, in one embodiment of the invention,

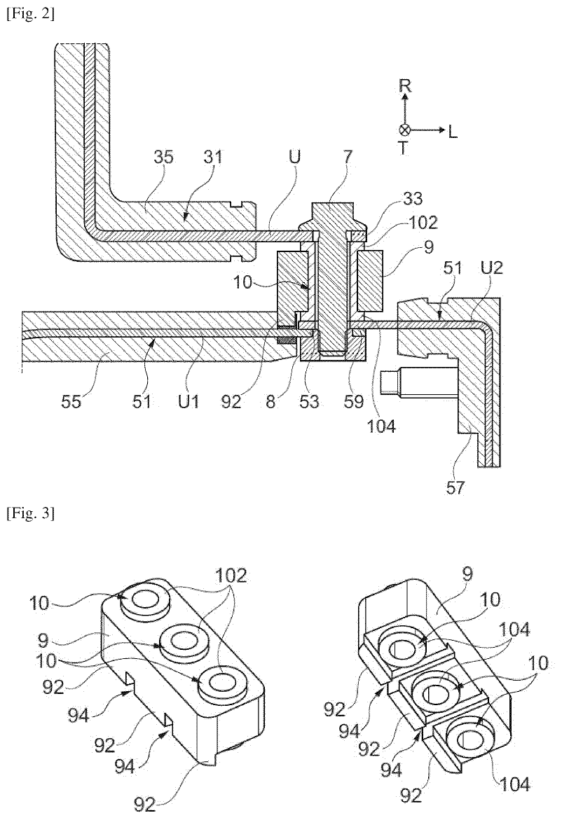

FIG. 2 is a sectional view of part of the electrical connection device of FIG. 1,

FIG. 3 illustrates two perspective views of overmolded conductive pads of the electrical connection device of FIG. 1,

FIG. 4 shows steps of a method for assembling an electrical connection device according to the invention, in one embodiment of the invention,

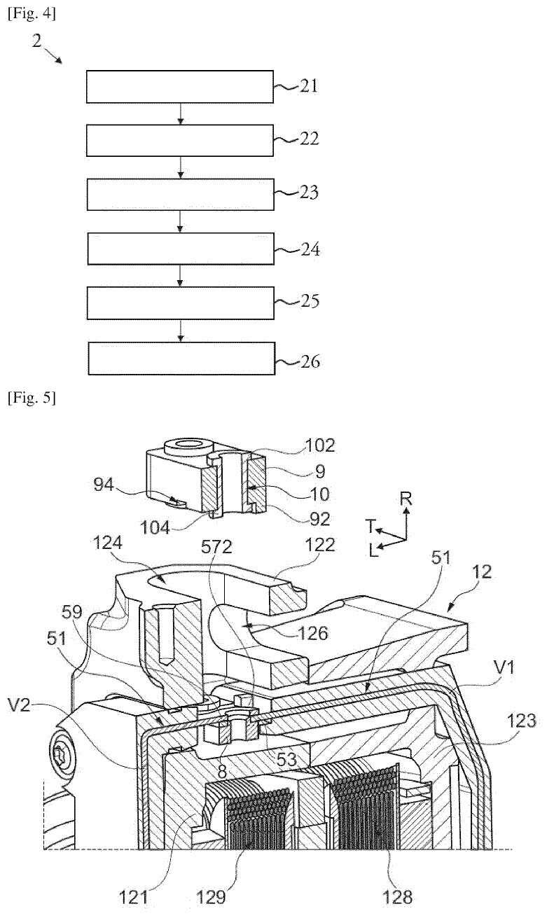

FIG. 5 shows a step of the assembling method of FIG. 4, corresponding to the conductive pads of FIG. 3 being inserted into an electrical machine,

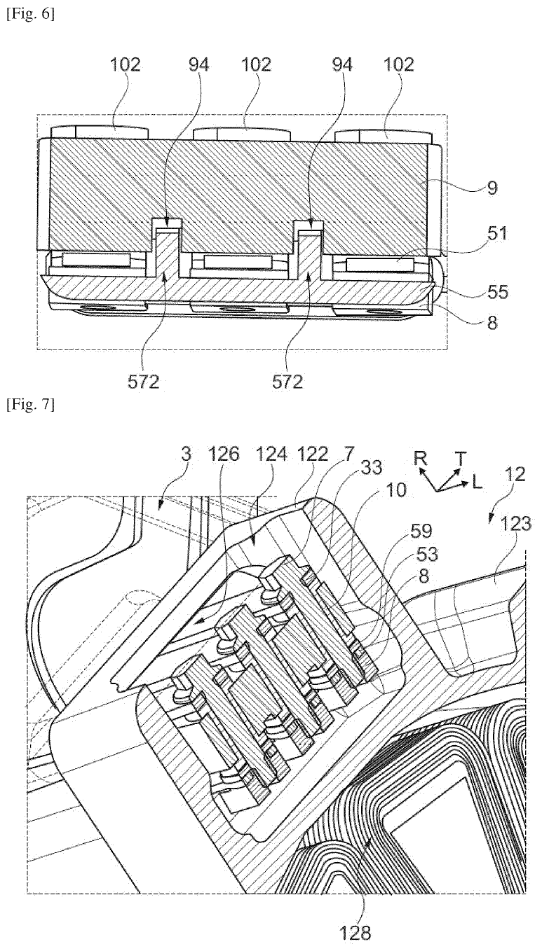

FIG. 6 shows a sectional view of the overmolding of the pads of FIG. 3 positioned on phase busbars of the electrical machine after the step of FIG. 5, and

FIG. 7 shows a sectional view of the electrical connection device according to the invention assembled in an electrical machine after the steps of the assembling method of FIG. 5.

In one exemplary use of the invention, a power electronics module (not shown) is connected firstly to a traction battery of an electric vehicle and secondly to an electrical machine 12 (shown in FIG. 5) to which it supplies three-phase current. In this example, the electrical machine 12 is an electrical traction machine of the electric vehicle. The power electronics module is electrically connected to the electrical machine 12 by way of an electrical connection device 1 according to the invention, shown in FIG. 1.

The electrical connection device I according to the invention comprises a plurality 3 of power supply busbars U, V, W intended to be connected to the power electronics module, and a plurality 5 of phase busbars intended to be connected to the electrical machine 12 (shown in FIG. 5). These busbars make it possible to carry a current of the order of tens of amperes. The power supply busbars U, V, W are each intended to be connected to one of the power supply phases at the output of the power electronics module.

With the electrical machine 12 comprising two stators 128 and 129 (visible in FIG. 5), the plurality 5 of phase busbars comprises first phase busbars U1, V1, W1 intended to be connected to the stator 128 and second phase busbars U2, V2, W2 intended to be connected to the stator 129. Moreover, in this embodiment of the invention, the electrical machine 12 is an axial-flux machine.

Those skilled in the art will know how to adapt this embodiment to a variant of the invention in which the electrical machine 12 is a single-phase or polyphase electrical machine with more than three phases, and/or in which the electrical machine 12 comprises a single stator or more than two stators, by adapting the number of power supply busbars and phase busbars of the electrical machine accordingly. The invention may also be transposed to use including a radial-flux electrical machine.

Returning to FIG. 1, the plurality 3 of power supply busbars U, V, W and the plurality 5 of phase busbars U1, V1, W1, U2, V2, W2 define pairs of busbar portions 31, 51 that are parallel to one another and spaced apart from one another. These pairs are each formed by a portion 51 of a phase busbar U1, V1, W1, U2, V2 or W2 and a portion 31 of a power supply busbar U, V or W. In this embodiment of the invention, each power supply busbar U, V or W comprises a portion 31 paired with a first phase busbar, respectively U1, V1 or W1, portion 51 or with a second phase busbar, respectively U2, V2 or W2, portion 51.

In each of these six pairs of portions 31, 51, the power supply busbar U, V or W portion 31 comprises a connection terminal 33 superimposed at a distance from a connection terminal of the phase busbar portion 51 of the pair, that is to say a connection terminal 53 of the first phase busbar, respectively U1, V1 or W1, portion 51, or a connection terminal 59 of the second phase busbar, respectively U2, V2 or W2, portion 51. The connection terminals 33, 53, 59 of the busbar portions 31, 51 are produced in the form of flat conductive rings.

In order to connect the portions 31, 51 of each pair of busbar portions 31, 51 to one another, conductive pads 10, shown in FIG. 2, make it possible to bridge the distance separating these portions 31, 51. More specifically, in this embodiment of the invention, each conductive pad 10 electrically connects the connection terminal 59 of the second phase busbar U2, V2 or W2 portion 51 to the connection terminal 33 of the power supply busbar, respectively U, V or W, portion 31. The connection terminals 59 of the second phase busbar U2, V2 or W2 portions 51 are each in contact with a connection terminal 53 of a first phase busbar, respectively U1, V1 or W1, portion 51, thereby making it possible to electrically connect the power supply busbar U, V or W portions 31 to the first phase busbar, respectively U1, V1 or W1, portions 51.

Each of these conductor assemblies in which a connection terminal 33 of a power supply busbar portion 31, a conductive pad 10, a connection terminal 59 of a second phase busbar portion 51, and a connection terminal 53 of a first phase busbar portion 51 are successively in contact is thus held so as to be assembled by way of a screw 7 passing through the conductive pad 10. The head of the screw 7 compresses the connection terminal 33 of a power supply busbar portion 31 of each of these assemblies and is screwed into a nut 8 that is welded to the connection terminal 53 of the first phase busbar U1, V1 or W1 portion 51 of this assembly, on the side opposite the connection terminal 59 of a second phase busbar, respectively U2, V2 or W2, portion of this assembly.

The screws 7 are holding means for holding the electrical connection device 1. As a variant, other holding means may be used, for example pins passing through each conductive pad 10 and locking under the connection terminal 53 of the first phase busbar U1, V1 or W1 portion 51 by virtue of retractable lugs arranged in the pins.

In order to promote electrical contact between the connection terminal 33 of a busbar U, V or W portion 31 and the corresponding conductive pad 10, the latter comprises a shoulder 102 at its end that comes into contact with this connection terminal 33. Similarly, in order to promote electrical contact between the connection terminal 59 of a second phase busbar U2, V2 or W2 portion and the corresponding conductive pad 10, the latter comprises a shoulder 104 at its end that comes into contact with this connection terminal 59.

The conductive pads 10 each extend longitudinally in a primary direction of elongation that corresponds, when the electrical connection device 1 is assembled and connected to the electrical machine 12, to a radial direction R, orthogonal to the power supply busbar portions 31 and phase busbar portions 51 of the electrical connection device 1. This radial direction R refers to the radial direction of the electrical machine 12, orthogonal to an axial direction L parallel to the axis of rotation of the electrical machine 12. The axial direction L also corresponds to a primary direction of elongation of the busbar portions 31 and 51 when the electrical connection device 1 is assembled and connected to the electrical machine 12. The direction orthogonal to this axial direction L and to the radial direction R is called the transverse direction T.

In order to facilitate the assembly of the electrical connection device 1, the conductive pads 10 are held together in an electrically insulating overmolding 9. This electrically insulating overmolding 9 forms a block from which the shoulders 102 and 104 of the conductive pads 10 project in their primary direction of elongation.

The plurality 3 of power supply busbars U, V, W itself comprises an insulating protection 35 overmolded on these power supply busbars. Similarly, the first phase busbars U1, V1, W1 comprise an insulating protection 55 overmolded around them, and the second phase busbars U2, V2, W2 comprise an insulating protection 57 overmolded around them.

The electrically insulating overmolding 9 comprises a lug 92 that serves as a stop in the event of a displacement in the axial direction of the second phase busbar U2, V2, W2 portions 51, aimed at superimposing their connection terminals 59 on the corresponding connection terminals 53 of the first phase busbar U1, V1, W1 portions 51.

The lug 92 therefore forms a positioning means for positioning the second phase busbars U2, V2, W2. Moreover, by being interposed between the overmolding 55 of the first phase busbars and the connection terminals 59 of the second phase busbars, the lug 92 also has a function of positioning the conductive pads 10 on the connection terminals 53 of the first phase busbar U1, V1, W1 portions 51. As a variant, the electrically insulating overmolding 9 furthermore comprises a similar positioning means for facilitating the positioning of the power supply busbars U, V, W.

As may be seen in FIG. 3, the electrically insulating overmolding 9 also comprises grooves 94 extending in the axial direction L and intersecting the lug 92 that extends along the electrically insulating overmolding 9 in the transverse direction T. These grooves 94 make it possible to center the conductive pads 10 on the connection terminals 53 of the first phase busbars U1, V1, W1, by virtue of corresponding ribs 572 (visible in FIGS. 5 and 6) of the insulating protection 57, which fit into the grooves 94.

The grooves 94 are therefore centering means for centering the conductive pads 10 on the connection terminals 53. As a variant, these centering means are ribs and the insulating protection 57 comprises corresponding grooves. In another variant, the electrically insulating overmolding 9 furthermore comprises similar centering means cooperating with the insulating protection 55 of the second phase busbars U1, V1, W1 or cooperating with the insulating protection 35 of the power supply busbars U, V, W in order to center the conductive pads 10 on their respective connection terminals 59 or 33.

A description will now be given, with reference to FIG. 4, of a method 2 according to the invention for assembling the electrical connection device 1 connecting the electrical machine 12 to the power electronics module.

A first step 21 of the method is that of electrically connecting the plurality 3 of power supply busbars U, V, W to the power electronics module.

A second step 22 of the method is that of electrically connecting the first phase busbars U1, V1, W1 to the corresponding stator 128 of the electrical machine 12.

A third step 23 of the method is that of electrically connecting the second phase busbars U2, V2, W2 to the corresponding stator 129 of the electrical machine 12. In this third step 23, the connection terminals 59 of the second phase busbar U2, V2, W2 portions 51 are additionally superimposed on the connection terminals 53 of the first phase busbar U1, V1, W1 portions 51, on the side opposite the nuts 8.

Of course, the order of the electrical connection steps may be modified, the connection terminals 53 and 59 of the first and second phase busbars being superimposed after they have been respectively electrically connected to the stators 128 and 129.

A fourth step 24 of the method, shown in FIG. 5, is that of inserting the conductive pads 10 into an orifice 124 in a wall 122 of the electrical machine 12, the orifice 124 making it possible to access, in the radial direction R, the connection terminals 53 and 59 of the first and second phase busbars U1, V1, W1, U2, V2, W2. The orifice 124 is arranged here on top of an interconnection housing formed in a radial extension of a casing 121 of the electrical machine 12, housing the stator 129, the other stator 128 being housed in a casing 123 of the electrical machine 12.

This insertion is therefore achieved primarily through a displacement in the radial direction R, that is to say in the radial direction R without any significant movement in the other directions. In this fourth step 24, the position in the axial direction L of the conductive pads 10 is ensured by the lug 92, and the position in the transverse direction T of the conductive pads 10 is ensured by virtue of the grooves 94 cooperating with the ribs 572, as shown in FIG. 6. The lug 92 also serves as a poka-yoke device by allowing the operator to turn the block formed by the conductive pads 10 and the electrically insulating overmolding 9 in the correct direction before it is inserted into the orifice 124.

The fifth step 25 is that of positioning 25 the connection terminals 33 of the power supply busbar U, V, W portions 31 so as to face the conductive pads 10, by passing the portions 31 of these power supply busbars through a hole 126 in the wall 122, shown in FIG. 7. This step 25 is carried out primarily through a displacement in the axial direction L of the electrical machine 12 toward the power electronics module, that is to say without any significant movement in the other directions. The hole 126 is arranged on a surface parallel to the transverse direction T and radial direction R of the wall 122, and the insulating protection 35 of the power supply busbars is surrounded by a seal (not shown) that closes off the hole 126 in sealtight fashion in this positioning step 25.

As a variant embodiment, step 25 is carried out through a displacement in the axial direction L of the power electronics module toward the electrical machine 12.

Finally, the last step 26 of the assembling method 2 according to the invention is that of holding by screwing the connection terminals 33, 53 and 59 to one another, using the screws 7 that lock in the nuts 8. Each screw passes through a connection terminal 33 of a power supply busbar U, V or W portion 31, a conductive pad 10, a connection terminal 53 of a first phase busbar, respectively U1, V1 or W1, portion 51 and a connection terminal 59 of a second phase busbar, respectively U2, V2 or W2, portion 51.

It should be noted that, in this embodiment of the invention, prior to the electrical connection steps 22 and 23, the electrical machine 12 is closed by screwing the casing 123 housing the stator 128 against the casing 121 housing the other stator 129, a rotor mounted on a rotor shaft also being housed between the two stators 128, 129 in these casings 121 and 123. Indeed, on the electrical machine 12, the first and second busbars are electrically connected to the stators 128 and 129 via the outside of the casing of the electrical machine 12. Other variants are of course conceivable with electrical machines in which the phase busbars are electrically connected before their casings are closed.

Of course, the invention is not limited to the examples that have just been described and many modifications may be made to these examples without departing from the scope of the invention.

1. An electrical connection device to electrically connect an electrical machine and a power electronics module, the electrical connection device comprising:
a plurality of phase busbars connectable to the electrical machine;
a corresponding plurality of power supply busbars connectable to the power electronics module,
said pluralities comprising pairs consisting of a phase busbar portion and a power supply busbar portion, the portions in each pair being spaced apart and parallel to one another,
said portions comprising connection terminals;
a plurality of conductive pads electrically connecting the connection terminals of the pairs, the conductive pads being configured to pass through at least one orifice in a wall of the electrical machine; and
a plurality of holding elements for holding the electrically connected connection terminals, at least one conductive pad being passed through by one of the holding elements.

2. The electrical connection device as claimed in claim 1, further comprising an electrically insulating overmolding that holds at least two of the conductive pads together.

3. The electrical connection device as claimed in claim 2, wherein the electrically insulating overmolding comprises positioning means for positioning the plurality of phase busbars.

4. The electrical connection device as claimed in claim 3, wherein the positioning means are formed by a lug configured to position the phase busbar portions in a primary direction of elongation of the phase busbar portions.

5. The electrical connection device as claimed in claim 2, wherein the electrically insulating overmolding comprises centering means for centering at least one of the conductive pads on at least one of the connection terminals.

6. The electrical connection device as claimed in claim 5, wherein the centering means comprise at least one groove able to receive at least one corresponding rib of an insulating protection of at least one of the pluralities of busbars.

7. The electrical connection device as claimed in claim 1, further comprising at least one nut mounted integrally with at least one of the connection terminals of the phase busbar portions, wherein the connection terminal is interposed between one of the conductive pads and the nut, the holding elements comprising at least one screw mounted in the conductive pad and screwed into the nut.

8. The electrical connection device as claimed in claim 2, wherein the conductive pads have a length greater than a dimension of the electrically insulating overmolding in a primary direction of elongation of the conductive pads.

9. The electrical connection device as claimed in claim 1, wherein, with the electrical machine comprising two stators, the plurality of phase busbars comprises two busbars per phase, connected together at one end of one of the conductive pads, the other end of the conductive pad being connected to a corresponding portion of a power supply busbar.

10. An assembly of an electrical machine and power electronics module, comprising an electrical connection device for electrically connecting the electrical machine to the power electronics module as claimed in claim 1.

11. A method for assembling an electrical connection device for electrically connecting an electrical machine to a power electronics module as claimed in claim 1, comprising:
electrically connecting the plurality of power supply busbars to the power electronics module;
electrically connecting the plurality of phase busbars to a stator of the electrical machine;
inserting the conductive pads into the at least one orifice in the wall of the electrical machine;
positioning the connection terminals of the power supply busbar portions so as to face the conductive pads; and
assembling the holding elements in the conductive pads.

12. The electrical connection device as claimed in claim 3, wherein the electrically insulating overmolding comprises centering means for centering at least one of the conductive pads on at least one of the connection terminals.

13. The electrical connection device as claimed in claim 4, wherein the electrically insulating overmolding comprises centering means for centering at least one of the conductive pads on at least one of the connection terminals.

14. The electrical connection device as claimed in claim 2, further comprising at least one nut mounted integrally with at least one of the connection terminals of the phase busbar portions, wherein the connection terminal is interposed between one of the conductive pads and the nut, the holding elements comprising at least one screw mounted in the conductive pad and screwed into the nut.

15. The electrical connection device as claimed in claim 3, further comprising at least one nut mounted integrally with at least one of the connection terminals of the phase busbar portions, wherein the connection terminal is interposed between one of the conductive pads and the nut, the holding elements comprising at least one screw mounted in the conductive pad and screwed into the nut.

16. The electrical connection device as claimed in claim 4, further comprising at least one nut mounted integrally with at least one of the connection terminals of the phase busbar portions, wherein the connection terminal is interposed between one of the conductive pads and the nut, the holding elements comprising at least one screw mounted in the conductive pad and screwed into the nut.

17. The electrical connection device as claimed in claim 5, further comprising at least one nut mounted integrally with at least one of the connection terminals of the phase busbar portions, wherein the connection terminal is interposed between one of the conductive pads and the nut, the holding elements comprising at least one screw mounted in the conductive pad and screwed into the nut.

18. The electrical connection device as claimed in claim 6, further comprising at least one nut mounted integrally with at least one of the connection terminals of the phase busbar portions, wherein the connection terminal is interposed between one of the conductive pads and the nut, the holding elements comprising at least one screw mounted in the conductive pad and screwed into the nut.

19. The electrical connection device as claimed in claim 3, wherein the conductive pads have a length greater than a dimension of the electrically insulating overmolding in a primary direction of elongation of the conductive pads.

20. The electrical connection device as claimed in claim 4, wherein the conductive pads have a length greater than a dimension of the electrically insulating overmolding in a primary direction of elongation of the conductive pads.
